(19) United States
(12) Patent Application Publication
(10) Pub. No.: US 2025/0205712 A1
(43) Pub. Date: Jun. 26, 2025

(54) MILL

(71) Applicant: Mirka Ltd, Jepua (FI)

(72) Inventor: Hans HEDE, Vörå (FI)

(21) Appl. No.: 18/845,811

(22) PCT Filed: Mar. 9, 2023
(86) PCT No.: PCT/FI2023/050133

§ 371 Date: Sep. 10, 2024

(30) Foreign Application Priority Data
Mar. 11, 2022 (FI) 20225220

(51) Int. Cl. B02C 7/12; B02C 7/08; B02C 7/14

(52) U.S. Cl. CPC B02C 7/12; B02C 7/08; B02C 7/14

(57) ABSTRACT

A mill that includes a first milling stone connected rotatably by an electric motor, a second milling stone arranged coaxially with the first milling stone, and a milling area formed by facing milling surfaces of the first milling stone and the second milling stone, wherein the milling area has a first portion formed by first facing portions of the facing milling surfaces of the first milling stone and the second milling stone and a second portion formed by second facing portions of the facing milling surfaces of the first milling stone and the second milling stone.

### TECHNICAL FIELD

The present invention relates to a mill.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

JP2006239518A discloses a mill with an upper stone and lower stone. the upper surface of the lower mill is normally configured as a conical surface projecting upward, and the lower surface of the upper mill is recessed in a conical shape that hangs on the center so as to match it. Since the surfaces have matching shapes, dimension of a gap between the stones is radially uniform between the stones. The lower stone can be moved toward the upper stone and away from the upper stone by a lever of the interval adjusting mechanism. If the lower stone is rotated and the stones are moved to contact each other by the lever, the stones experience a high friction which can stop the rotational movement and eventually break the motor.

### SUMMARY

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to some aspects, there is provided the subject matter of the independent claims. Some further aspects are defined in the dependent claims. The embodiments that do not fall under the scope of the claims are to be interpreted as examples useful for understanding the disclosure.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a mill in accordance with at least some embodiments;

FIGS. 2 and 3 illustrate enlargements of parts of the mill illustrated by FIG. 1;

FIG. 4 illustrates a mixing/feeding wheel inside the mill of FIG. 1 as seen from a side of the mixing/feeding wheel towards an input passage of the mill; and

FIG. 5 illustrates a gap adjustment component connected to the mill of FIG. 1.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Identical or corresponding functional and structural elements which appear in the different drawings are assigned the same reference numerals. When the words first and second are used to refer to different elements, it is to be understood that this does not necessarily imply or mean that the first and second elements are somehow structurally substantially different elements or that their dimensions are substantially different unless specifically stated.

It should be noted that in the following, numeric values for dimensions are presented using comma for separating decimals.

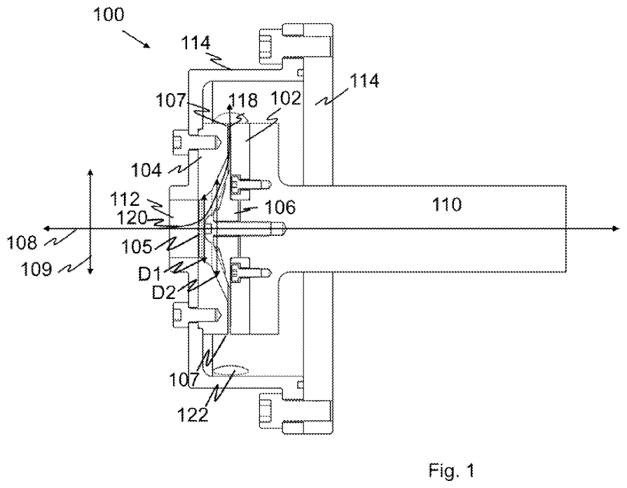

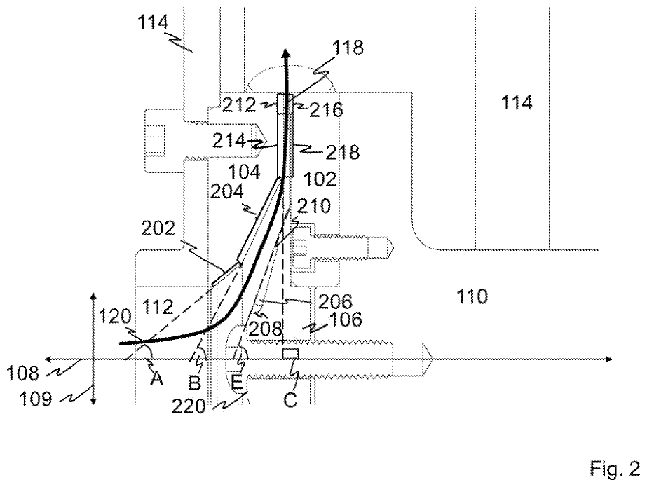

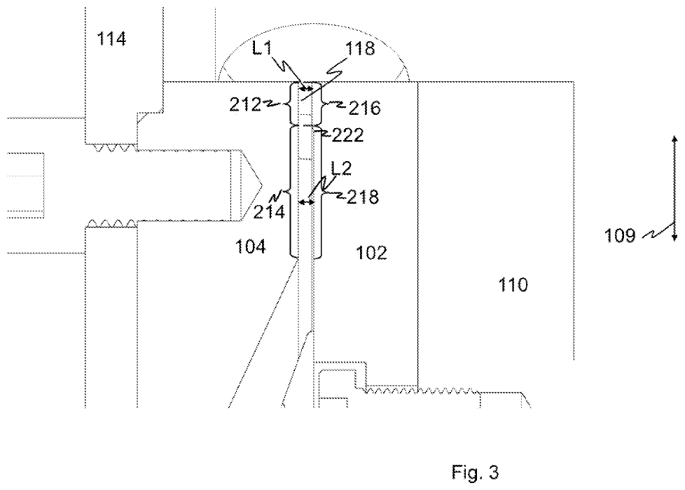

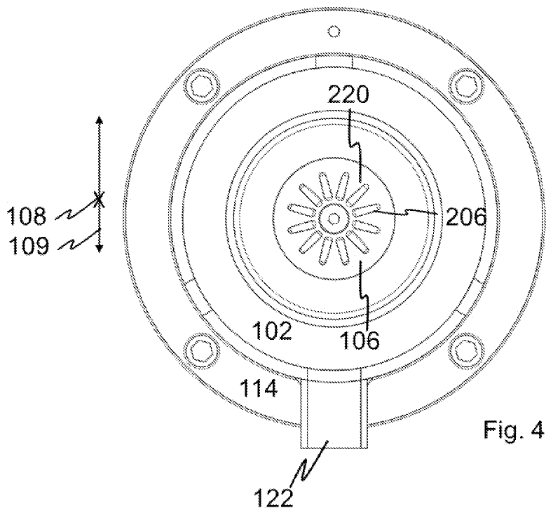

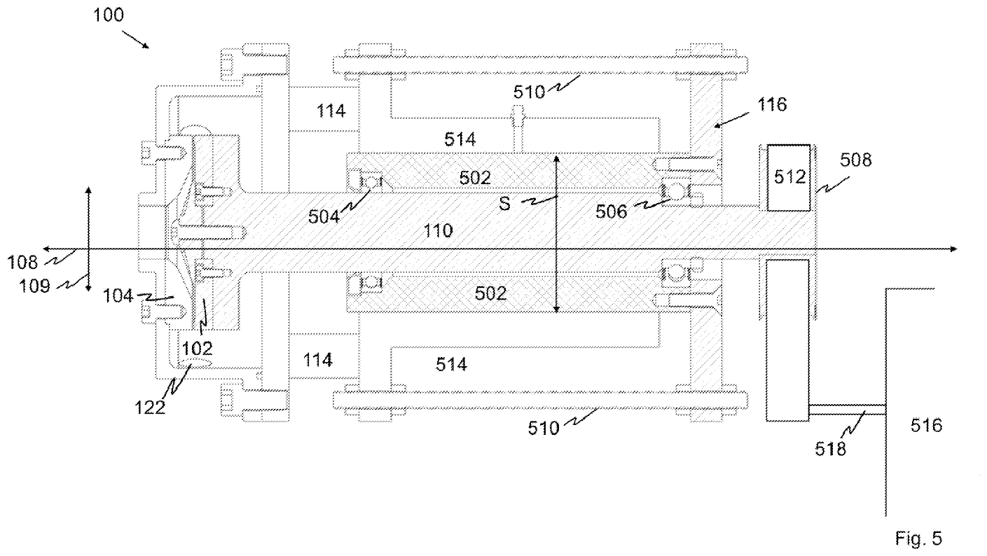

FIG. 1 illustrates an example of a mill in accordance with at least some embodiments. The mill 100 is illustrated by a cross-section of the mill. The cross-section shows in a plane defined by an axial direction 108 and a radial direction 109 of the mill. FIGS. 2 and 3 illustrate enlargements of parts of the mill illustrated by FIG. 1. FIG. 4 illustrates a mixing/feeding wheel inside the mill of FIG. 1 as seen from a side of the mixing/feeding wheel towards an input passage of the mill. It should be noted that in FIG. 4 some parts of the mill have been hidden/removed in order to show the mixing/feeding wheel at its position inside the mill. FIG. 5 illustrates a gap adjustment component connected to the mill of FIG. 1. Patterning has been applied to a part of the items shown in FIG. 5 for illustrative purposes. In the following various examples in accordance with at least some embodiments are described with reference to the FIGS. 1, 2, 3, 4 and 5.

The mill 100 comprises a first milling stone 102 connected to a rotor shaft 110, or drive shaft, and a second milling stone 104 arranged coaxially with the first milling stone 102. Material to be milled is fed through a center of the second milling stone 105 and centrifuged out at radially outer edges of the milling stones 107, where intense milling takes place. Path of the material milled by the mill is illustrated by an arrow 120. The mill may comprise a frame 114 that houses the milling stones. The frame may comprise a hole, or an outlet 122, at an outer circumference of the frame 114 for allowing the milled material to exit the mill.

In an example, the milling stones may have the same diameter e.g. 50 mm-300 mm in the radial direction 109, and the milling stones may be in very close proximity of each other for milling the material by the mill.

In an example, the milling stones are made of metal, for example by machining such as rotary cutting and casting. The metal preferably has resistivity against acids and/or corrosion.

The rotor shaft 110 may be directly driven by a motor, e.g. an electric motor, whereby the first milling stone 102 may be rotated by the motor about an axis of rotation. The axis of rotation of the first milling stone may define the axial direction 108. It should be noted that the axis of rotation may be referred to in the following as the axis or the axis of rotation. Further it should be noted that in the FIGS. 1, 2, 4 and 5, the axial direction is illustrated at the axis of rotation. Accordingly, the axial direction illustrated in FIGS. 1, 2, 4 and 5 is a geometrical extension of the axis. It should be noted that instead of the rotor shaft being directly driven by the motor the rotor shaft may be driven by the motor indirectly via a belt-drive. FIG. 5 illustrates an example of the belt-drive, where an electric motor 516 is connected by a belt 512 to a pulley 508 at the rotor shaft 110. The rotational speed may be e.g. 500-10000 rpm.

The second milling stone 104 may be static and for example connected to the frame 114 of the mill. The frame may comprise a first portion configured to support the second milling stone 104 coaxially with the first milling stone 102 and a second portion that is configured static with respect to the first milling stone 102. It should be noted that instead of driving only one of the milling stones also both of the milling stones may be driven the same motor, or each milling stone may be driven by a separate motor.

It should be noted that the first milling stone 102 and the second milling stone 104 may be arranged side-by-side as illustrated in the FIG. 1 or the first milling stone and the second milling stone may be positioned on top of each other. In an example, the milling stone that is connected to the rotor shaft 110, e.g. the first milling stone, may be referred to an inner milling stone, whereby the second milling stone may be referred to an outer milling stone. In a further example, the first milling stone may be referred to a lower milling stone and the second milling stone may be referred to an upper milling stone, when the first milling stone and the second milling stone are positioned on top of each other in a vertical direction.

The first milling stone 102 and the second milling stone 104 may each comprise at least one milling surface for milling the material. The milling stones are arranged with respect to each other such that the milling surfaces of the milling stones are facing each other. The milling surfaces of the first milling stone and the second milling stone form a milling area. The milling area comprises two portions for milling material under different conditions, e.g. under different pressures. The milling areas may be ring-like areas of the milling surfaces of the milling stones. Accordingly, the milling surfaces of the milling stones may comprise first portions, e.g. ring-like areas, that form a first milling area and second portions, e.g. ring-like areas, that form a second milling area. The first portions of the milling stones may be positioned around the second portions in the radial direction 109. In an example the different conditions at the two portions of the milling area may be provided by a shape of at least one of the milling stones and/or different distances, ‘L1’, ‘L2’ between facing milling surfaces of the milling stones. In an example, a gap 118 between the milling stones may have a different dimension at one portion of the milling area than at another portion of the milling area. In other words, a distance between the milling stones may be different at different portions of the milling area. When the milling stones are moved towards each other and eventually in contact each other, the gap is closed at only one of the milling areas, whereby a frictional force caused by a contact of the facing milling surfaces is smaller than if the facing surfaces over the whole milling area would be in contact. This facilitates driving the mill, when the milling surfaces are in contact with each other at least for a short period of time without necessarily causing damage to the motor. Therefore, the gap may be safely adjusted, while the motor is driving the first milling stone. For example, a portion of the milling area that is radially closer to outer edges of the milling stones may have a smaller distance between the milling stones than another portion of the milling area that is radially further away from the outer edges of the milling stones. The outer edges of the milling stones are at outer perimeters of the milling stones, where milled material leaves the mill. In an example the first milling stone may comprise a stepped milling surface, whereby a distance ‘L1’ between the first facing milling surfaces is less than a distance ‘L2’ between the second facing milling surfaces. The stepped milling surface may comprise a step 222 between a first portion of the milling surface and a second portion of the milling surface. Step size of the stepped milling surface may be from 10 to 30 micrometers, for example 20 micrometers.

The two portions of the milling area may be located at radially different positions on the facing surfaces of the milling stones. One of the portions of the milling area may be formed by first facing portions 212, 216 of the facing milling surfaces and another portion of the milling area may be formed by second facing portions 214, 218 of the facing milling surfaces. The first facing portions of the facing milling surfaces may be positioned radially further away from the axial direction 108 than the second facing portions of the facing milling surfaces. A radial dimension of the milling area formed by the first facing portions of the milling surfaces may be from 2-5 mm to 1-2 cm, when the milling stones have diameters of 50 mm-300 mm. Accordingly, the first facing portions of the facing milling surfaces may be positioned closer to outer edges of the milling stones than the second facing portions of the facing milling surfaces.

The mill may comprise a gap adjustment component 116 connected operatively to at least one of the milling stones for adjusting a gap between the milling surfaces. In an example, the gap adjustment component may be configured to adjust the gap 118 by moving the first milling stone 102 in relation to the second milling stone 104. In an example, the gap between the milling stones may be less than 1 mm for example less than 0.5 mm. The gap adjustment component may be configured for adjusting the gap in in micrometer scale steps, e.g. in steps of a few micrometers or tens of micrometers, e.g. 1, 2 or 3 or 10, 20 or 30 micrometers. Preferably the gap between the milling stones is adjustable from 0 nanometers to a few microns depending on the media to be milled.

In an example, the gap adjustment component 116 may be configured to adjust a position of the rotor shaft 110 in the axial direction 108, thus towards and away from the second milling stone. In this way the position of the first milling stone that is connected to the rotor shaft, and effectively the gap 118 between the milling stones may be adjusted. The gap adjustment component may comprise a sleeve portion, or an inner sleeve portion, 502 that is connected to the rotor shaft by bearing assemblies 504, 506 that allow rotation of the rotor shaft. Accordingly, the rotor shaft is connected rotatably to the inner sleeve portion. The frame 114 is provided with an outer sleeve portion 514 and the inner sleeve portion is at least partially inside the outer sleeve portion such that the inner sleeve portion 502 and the outer sleeve portion 514 are movable with respect to each other by a sliding movement in the axial direction 108, Accordingly, the rotor shaft is positioned inside the inner sleeve portion, whereby the rotor shaft may be moved in the axial direction together with the inner sleeve portion. The rotor shaft may extend out of the inner sleeve portion in the axial direction at both ends of the inner sleeve portion. In accordance with the example described in FIG. 5, the first milling stone 102 may be connected to the rotor shaft at one end, e.g. mill end, of the rotor shaft and the pulley 508 may be connected to the rotor shaft at an opposite end, drive end, of the rotor shaft. The frame 114 of the mill may comprise a sleeve portion 514, or an outer sleeve portion, that extends in the axial direction 108 and encloses at least partially the inner sleeve portion. The inner sleeve portion may be positioned at least partially inside the outer sleeve portion, and the inner sleeve portion and the outer sleeve portion are movable with respect to each other by a sliding movement. In this way the rotor shaft may be supported to its position in the radial direction 109 and the rotor shaft can be moved in the axial direction for moving the position of the first milling stone with respect to the second milling stone and adjusting the gap 118 between the milling stones. It should be noted that, when the outer sleeve portion and the inner sleeve portion are arranged to extend in their longitudinal directions parallel with the axial direction according to the illustration in FIG. 5, both the outer sleeve portion and the inner sleeve portion have one end towards the first milling stone and one end towards the pulley 508. The inner sleeve portion may have an outer radial surface extending in the axial direction and the outer sleeve portion may have an inner radial surface extending in the axial direction. When the inner sleeve portion is positioned at least partially inside the outer sleeve portion, the outer radial surface of the inner sleeve portion may be in contact with the inner radial surface of the outer sleeve portion. In this position the inner sleeve portion and the outer sleeve portion may be moved, by the sliding movement, with respect to each other in the axial direction 108. The sliding movement may be facilitated by providing a lubricant on the contacting surfaces of the inner sleeve portion and outer sleeve portion. In an example, an outer diameter of the inner sleeve portion 502 may be matched to an inner diameter ‘S’ of the outer sleeve portion 514 for achieving a tight fit between the inner sleeve portion and the outer sleeve portion.

It should be noted that the inner sleeve portion may be connected to the frame 114 by one or more threaded taps 510. Each of the threaded taps may comprise one end connected to the inner sleeve portion at the end of the inner sleeve portion towards the pulley 508, and each of the threaded taps may comprise another end connected to the frame 114. When the threaded taps are rotated in one direction, the inner sleeve may be moved, or drawn, towards the first milling stone and inside the outer sleeve portion. This moves the rotor shaft 110 and the first milling stone 102, which reduces or even closes the gap 118 at the first milling area.

When the threaded taps are rotated in an opposite direction, the inner sleeve may be moved away from the first milling stone and out of the outer sleeve portion 514. This increases the gap 118 at the milling area.

The mill 100 may process material by mixing and grinding the material. The material to be processed may be fed to the mill via an input passage 112 of the frame 114. The input passage may be formed by an opening at the frame. The input passage may serve for feeding the material to a conically reducing passage connected to the input passage. The conically reducing passage may extend between one end of the passage comprising an axial opening at an outer surface, e.g. at the center 105, of the second milling stone 104 and an opposite end of the passage at the milling area between the milling stones. The axial opening may be positioned on the axis of rotation. In an example, the conically reducing passage extends through the second milling stone, whereby the second milling stone forms one or more radial surfaces 202, 204 that form outer walls of the conically reducing passage. The radial surfaces may be inclined such that radial distances ‘D1’, ‘D2’, e.g. inner diameters of the second milling stone between the radial surfaces 202, 204, between opposite sides of the radial surfaces continuously increase from the opening at the outer surface to an opening to the milling area at the opposite end of the passage, thus towards the first milling stone. Accordingly, the one or more radial surfaces 202, 204 are deflected with respect to the axial direction 108.

The outer surface of the second milling stone 104 is towards the input passage 112, thus on an opposite side of the second milling stone with respect to the milling surface of the second milling stone. The conically reducing passage transports the material received through the axial opening of the second milling stone to the milling surfaces of the milling stones at the milling area. At the end of the conically reducing passage towards the milling area, material from the conically reducing passage is received at the milling surface of the first milling stone 102. When the material reaches the milling surface of the first milling stone 102, the material flows in the radial direction 109 to the gap 118 between the milling stones and the milling area by a centrifugal force caused by rotation of the first milling stone.

In an example, the conically reducing passage may be limited in the radial direction 109 by one or more walls, or radial surfaces 202, 204, of the second milling stone which extend between the input passage 112 and the first milling stone 102 and are deflected with respect to the axial direction 108. In this way a conical shape of the cross-section of the conically reducing passage may be formed and the conically reducing passage may feed the material to the milling area that is radially offset from the axis of rotation of the first milling stone such that the pressure at the milling area may be higher than at the end of the conically reducing passage receiving the material. It should be noted that the radial surfaces 202, 204 are inner surfaces of the second milling stone inside the conically reducing passage through the second milling stone. In an example, the one or more walls of the second milling stone may be inclined such that their distance to the axis increases towards the first milling stone. Accordingly, distances ‘D1’, ‘D2’, between the radial surfaces of the second milling stone increase from the opening at the outer surface to an opening at the opposite end of the passage to the milling area. It should be noted that the radial surfaces 202, 204 are inner surfaces of the second milling stone inside the conically reducing passage through the second milling stone.

In an example the one or more walls of the second milling stone 104 may comprise a first wall, or radial surface 202, inclined with respect to the axis by angle ‘A’ and a second wall, or radial surface 204, inclined with respect to the axis by angle ‘B’, such that ‘B′>′A’. The first wall is located at a side of the conically reducing passage towards the input passage 112 and the second wall is located at a side of the conically reducing passage towards the first milling stone 102. It should be noted that the one or more inclined walls of the second milling stone are inclined also with respect to the milling area. The milling surfaces at the milling area may have an angle ‘C’, e.g. a right angle, with the axis, whereby ‘C′>′B′>′A’.

The mill 100 may comprise a mixing/feeding wheel, or a combined mixing and feeding wheel, 106 that is connected to the mill coaxially with the first milling stone 102. The mixing/feeding wheel provides mixing of material fed into the conically reducing passage and feeding the material to the milling area. Connecting the mixing/feeding wheel to the mill coaxially with the second milling stone 104 provides that the mixing/feeding wheel and both of the milling stones 102,104 are arranged on the axis of rotation. In an example, the mixing/feeding wheel may be connected to the mill to be rotatable together with the first milling stone, whereby the mixing/feeding wheel is secured to its position in the mill. In an example, the milling stones and the mixing/feeding wheel all have a circular shape. The circular shapes may be defined by corresponding radial dimensions about the axis of rotation. In an example, the mixing/feeding wheel has a cross-section of a conical shape in the plane defined by the axial direction 108 and the radial direction 109. The conical shape of the mixing/feeding wheel has an increasing radius towards the first milling stone 102, when the mixing/feeding wheel is positioned along the axis with its tip 220 towards the input passage 112. The tip may have a passage for a fastener, e.g. a bolt, for securing the mixing/feeding wheel to its position in the mill. Accordingly, the radius of the mixing/feeding wheel is increasing away from the input passage. In this way the mixing/feeding wheel may be shaped and dimensioned to have a conical cross-section that fits inside the second milling stone, when the mixing/feeding wheel and the second milling stone are arranged coaxially to the mill. In this position the mixing/feeding wheel forms the conically reducing passage together with the one or more walls, or radial surfaces 202, 204, of the second milling stone which extend between the input passage 112 and the first milling stone. The one or more walls of the second milling stone are inclined such that their distance to the axis increases towards the first milling stone. The cross-section of the mixing/feeding wheel comprises sides towards the one or more walls of the second milling stone and the sides are inclined with respect to the axis at an angle ‘E’ such that ‘E′>′B′>′A’. In this way the conically reducing passage may be formed by the second milling stone and the mixing wheel. The mixing/feeding wheel may comprise a plurality of grooves 206 facing towards the one or more walls of the second milling stone. Accordingly, the grooves may be arranged to a side of the mixing/feeding wheel facing towards the input passage 112, whereby the grooves may be open towards the input passage and the material fed into the conically reducing passage may be brought in contact with the grooves. On an opposite side of the mixing/feeding wheel with respect to the grooves, the mixing/feeding wheel may be facing, e.g. in contact with, the first milling stone. The plurality of grooves may extend radially from the center of the mixing wheel, i.e. from the tip or close to the tip, towards a peripheral edge of the mixing wheel. The grooves may extend very close to the peripheral edge of the mixing/feeding wheel or all the way to the peripheral edge of the mixing wheel. The grooves may be spaced evenly on the mixing wheel, whereby the side of the mixing/feeding wheel facing towards the input passage 112 may be evenly covered by the grooves. Each of the grooves may comprise one end 208 towards the center of the mixing/feeding wheel and an opposite end 210 towards the peripheral edge of the mixing wheel. The end 210 towards the peripheral edge of the mixing/feeding wheel may be a closed end, whereby the peripheral edge closes the groove, or the end 210 towards the peripheral edge of the mixing/feeding wheel may be an open end, whereby the open end may form a part of the peripheral edge of the mixing wheel. The grooves may have increasing depths from the center of the mixing/feeding wheel to the peripheral edge. The depth of the grooves affects friction between the material and the mixing/feeding wheel. The friction between the mixing/feeding wheel and the material provides that the mixing/feeding wheel may feed the material towards the milling area by pumping the material within the conically reducing passage. The deeper the grooves are, the higher the friction between the material, e.g. liquid, and the mixing/feeding wheel is and the higher the pumping and feeding effect of the mixing/feeding wheel is.

In an example operation of the mill comprising the conically reducing passage and the mixing wheel, the material is received from the input passage 112 and pre-mixed and pumped by the mixing/feeding wheel 106 within the conically reducing passage. The conically reducing passage may comprise one or more walls, or surfaces 202, 204, of the second milling stone that are deflected with respect to the axial direction 108. The mixing/feeding wheel may be conically shaped such that the one or more walls of the second milling stone and the mixing/feeding wheel together form the conically reducing passage, where the distance between the second milling stone and the mixing/feeding wheel is reducing towards the milling area. In this way the material fed to the conically reducing passage experiences an increasing pressure when the material is moved along the conically reducing passage to the milling area. Once the material reaches the first milling stone at the end of the conically reducing passage the material is moved by the centrifugal force to the milling area. At the milling area the material is first mixed at the second portion of the milling area that has a greater distance between the milling stones than the first portion of the milling area. Accordingly, the pressure applied to the material at the milling area is increasing from the second portion of the milling area to the first portion of the milling area.

In an example in accordance with at least some embodiments, there is provided a mill 100 comprising
a first milling stone 102 connected rotatable by an electric motor, a second milling stone 104 arranged coaxially with the first milling stone 102, and
a milling area formed by facing milling surfaces of the first milling stone 102 and the second milling stone 104, wherein the milling area comprises a first portion formed by first facing portions 212, 216 of the facing milling surfaces of the first milling stone 102 and the second milling stone 104 and a second portion formed by second facing portions 214, 218 of the facing milling surfaces of the first milling stone 102 and the second milling stone 104. The two portions of the milling area provide that material may be milled under different conditions, e.g. different pressures and distances between the facing milling surfaces, at the milling area.

In an example in accordance with at least some embodiments, the mill comprises a first distance between the first facing portions 212, 216 of the facing milling surfaces and a second distance between the second facing portions 214, 218 of the facing milling surfaces and the first distance is smaller than the second distance. Accordingly, a gap 118 between the milling stones is decreased from the second portion of the milling area to the first portion of the milling area and a pressure caused to material flowing through the milling area from the second portion of the milling area to the first portion of the milling area is increased. Thereby, since the distance between the first facing portions 212, 216 is smaller than the distance between the second facing portions 214, 218, a size of the gap at the milling area decreases in the radial direction 109 outwards from the axis, thus the gap is a radially decreasing gap. In an example, when the milling stones are moved towards each other and eventually in contact each other, the gap is closed at only one of the milling areas, whereby a frictional force caused by a contact of the facing milling surfaces is smaller than if the facing surfaces over the whole milling area would be in contact. This facilitates driving the mill, when the milling surfaces are in contact with each other at least for a short period of time without necessarily causing damage to the motor. When the mill is driven in this position, the contacting portions of the milling surfaces are worn, thus forming two absolute parallel rotating planes formed by the first facing portions 212, 216. When the milling stones are then moved apart, a gap formed by the first facing portions 212, 216 is accurate in the sub micrometer range without destroying shafts or motors during running. In an example, a radial dimension of the milling area formed by the first facing portions of the milling surfaces may be from 2-5 mm to 1-2 cm, when the milling stones have diameters of 50 mm-300 mm. Therefore, the gap may be safely adjusted, while the motor is driving the first milling stone even if very small gap size should be attained by manual adjustment. The adjustment of the gap may be performed in a preliminary run of the mill for forming the parallel rotating planes by the first facing portions 212, 216 and adjusting the gap to a target size. After the preliminary run, the mill may be used for production.

In an example in accordance with at least some embodiments, the first facing portions 212, 216 have a smaller dimension in a radial direction 109 than the second facing portions 214, 218. The smaller radial width of the gap 118 at the first facing portions 212, 216 allows that the frictional force caused by the first facing portions 212, 216 brough into contact is small enough for driving the mill without destroying shafts or motors during running, when the first facing portions of the facing milling surfaces are in contact with each other. In this way two absolute parallel rotating planes may be formed by the first facing portions 212, 216 by driving the mill. When the milling stones are then moved apart, a gap formed by the first facing portions 212, 216 is accurate in the sub micrometer range without destroying shafts or motors during running. In an example, a radial dimension of the milling area formed by the first facing portions of the milling surfaces may be from 2-5 mm to 1-2 cm, when the milling stones have diameters of 50 mm-300 mm.

In an example in accordance with at least some embodiments, the mill 100 comprises a conically reducing passage extending between an axial opening at an outer surface of the second milling stone 104 and the milling area. In an example, material fed to the conically reducing material travels from the conically reducing passage to the first milling stone and from the first milling stone the material is transported by a centrifugal force caused by rotation of the first milling stone to a gap 118 between the milling stones, where the milling area is located. At the milling area the material is first processed by a second portion of the milling area and from the second portion of the milling area the material is transported by the centrifugal force, thus radially away from the axis, to a first portion of the milling area, where final milling of the material takes place.

In an example in accordance with at least some embodiments, the conically reducing passage comprises one or more radial surfaces of the second milling stone 104 extending towards the first milling stone 102 and said one or more radial surfaces of the second milling stone 104 being deflected with respect to the axial direction 108. In this way the conically reducing passage may feed the material to the milling area that is radially offset from the axis of rotation of the first milling stone.

In an example in accordance with at least some embodiments, the mill comprises a mixing/feeding wheel 106 arranged coaxially with the first milling stone 102 and said mixing/feeding wheel 106 having a conical shape with an increasing radius towards the first milling stone 102. In this way the conically reducing passage may be formed by facing surfaces of the second milling stone and the mixing wheel. In an example, the mixing/feeding wheel may extend in the axial direction 108 from the first milling stone towards the opening of the conical passage at the outer surface of the second milling stone, and in the radial direction 109 between radial surfaces of the second milling stone. It should be noted that the increasing radius of the mixing/feeding wheel provides that the surface of the mixing/feeding wheel is inclined with respect to the radial surfaces of the second milling stone, whereby the conical passage has a reducing radial dimension from the input passage 112 towards the first milling stone.

In an example in accordance with at least some embodiments, the mixing/feeding wheel 106 comprises radially extending grooves 206. The grooves support pre-mixing the material fed to the mill before the material is processed at the milling area.

In an example in accordance with at least some embodiments, the mill 100 comprises a frame 114 comprising a first portion configured to support the second milling stone 104 coaxially with the first milling stone 102 and a second portion that is configured static with respect to the first milling stone 102, and the mill comprises a gap adjustment component 116 for adjusting a gap 118 between the first milling stone 102 and the second milling stone 104. In an example the gap adjustment component 116 may be configured to adjust a position of the rotor shaft 110 in the axial direction 108, thus towards and away from the second milling stone. In this way the position of the first milling stone and effectively the gap between the milling stones may be adjusted. In another example (not illustrated), the gap adjustment component may be configured to adjust a position of the second milling stone in the axial direction, thus towards and away from the first milling stone. In this way the position of the second milling stone and effectively the gap between the milling stones may be adjusted.

It should be note that in the foregoing any direction in the radial direction 109 of the mill 100 may be a direction that is parallel to the radial direction and or any direction in the axial direction 108 of the mill may be a direction that is parallel to the axial direction. A direction that is parallel with the radial direction 109 or the axial direction 108 may be determined on the basis of a comparison of the direction with the radial direction or the axial direction. In an example, the direction may be evaluated to determine whether the direction is parallel with the radial direction or the axial direction. The direction may be divided into components of a coordinate system, such as a cartesian coordinate system spanned in X, Y and Z-dimension, whereby one of the X, Y and Z-dimensions may be aligned with the radial direction or the axial direction. Then, a length of the components of the evaluated direction may be compared with each other and if the component with the highest value is in the direction of the dimension that Is aligned with the radial direction or the axial direction, the direction may be determined to be parallel based on the alignment of the direction with the radial direction or the axial direction. In a simple example, if an evaluated direction has only a component in the X-direction, that is aligned with the radial direction, the evaluated direction may be determined to be parallel with the radial direction. In another example, if an evaluated direction has X, Y and Z-components such that the X-component has the highest value, X>Y>Z, then if the X-direction is aligned with the radial direction, the evaluated direction may be determined to be parallel with the radial direction.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

### REFERENCE SIGNS

100 Mill
102,104 Milling stones
105 Center of milling stone
106 Mixing/feeding wheel
107 Radially outer edges of milling stones
108 Axial direction
109 Radial direction
110 Rotor shaft
112 Input passage
114 Frame
116 Gap adjustment component
118 Gap
120 Arrow illustrating path of material
122 Outlet
202, 204 Radial surfaces of milling stone
206 Groove
208,210 Ends of groove
212, 214,
216, 218 Portions of milling surfaces
220 Tip of mixing/feeding wheel
222 Step of milling surface
502,514 Sleeve portions
504,506 Bearing assemblies
508 Pulley
510 Threaded tap
512 Belt
516 Electric motor
518 Output shaft of electric motor
A,B Angles of surfaces with axis
C Angle of milling surface with axis
Distance between radial surfaces of milling stone
D1,D2 inside conically reducing passage
E Angle between side of mixing/feeding wheel and axial direction
L1,L2 Distances between facing milling surfaces

1. A mill comprising:
a first milling stone connected rotatable by an electric motor,
a second milling stone arranged coaxially with the first milling stone,
a milling area formed by facing milling surfaces of the first milling stone and the second milling stone, wherein the milling area comprises a first portion formed by first facing portions of the facing milling surfaces of the first milling stone and the second milling stone and a second portion formed by second facing portions of the facing milling surfaces of the first milling stone and the second milling stone, wherein a first distance between the first facing portions of the facing milling surfaces is smaller than a second distance between the second facing portions of the facing milling surfaces, and the first facing portions of the facing milling surfaces and the second facing portions of the facing milling surfaces are configured to extend in directions that are parallel to a radial direction of the mill,
a conically reducing passage extending between an axial opening at an outer surface of the second milling stone and the milling area, and
a mixing/feeding wheel arranged coaxially with the first milling stone and said mixing/feeding wheel having a conical shape with an increasing radius towards the first milling stone
wherein a conically reducing passage is formed by the mixing wheel and one or more walls of the second milling stone, whereby a distance between the second milling stone and the mixing/feeding wheel is reducing towards the milling area.

2. The mill according to claim 1, wherein the first facing portions have a smaller dimension in a radial direction than the second facing portions.

3. (canceled)

4. The mill according to claim 1, wherein the conically reducing passage comprises one or more radial surfaces of the second milling stone, said one or more radial surfaces extending between the axial opening and the first milling stone and being deflected with respect to the axial direction.

5. (canceled)

6. The mill according to claim 1, wherein the mixing/feeding wheel comprises radially extending grooves.

7. The mill according to claim 1, comprising a frame comprising a first portion configured to support the second milling stone coaxially with the first milling stone and a second portion that is configured static with respect to the first milling stone, and the mill comprises a gap adjustment component for adjusting a gap between the first milling stone and the second milling stone.

8. The mill according to claim 7, wherein the first milling stone is connected to one end of a rotor shaft, and the gap adjustment component comprises an outer sleeve portion provided at the frame and an inner sleeve portion positioned at least partially inside the outer sleeve portion, whereby an outer radial surface of the inner sleeve portion is in contact with an inner radial surface of the outer sleeve portion and the inner sleeve portion and the outer sleeve portion are movable with respect to each other by a sliding movement in the axial direction, and the rotor shaft is positioned inside the inner sleeve portion and connected rotatably to the inner sleeve portion, wherein the inner sleeve portion is connected by one or more threaded taps to the frame or adjusting the gap by moving the inner sleeve portion by rotation of the one or more threaded taps.
